(19) United States
(12) Patent Application Publication
(10) Pub. No.: US 2017/0286498 A1
(43) Pub. Date: Oct. 5, 2017

(54) Search Result Visualization for Preserving Score Distribution Information

(71) Applicant: Adobe Systems Incorporated, San Jose, CA (US)

(72) Inventors: Tim Gollub, Weimar (DE); Nedim Lipka, Santa Clara, CA (US); Eunyee Koh, San Jose, CA (US)

(21) Appl. No.: 15/083,619

(22) Filed: Mar. 29, 2016

(51) Int. Cl. G06F 17/30

(52) U.S. Cl. CPC G06F 17/30554; G06F 17/30867; G06F 17/3053; G06F 17/30598

(57) ABSTRACT

A system and method for providing query results with visual cues is described. The visual cues, such as variation in color, typography (e.g., size, spacing, etc.), layout, etc., indicate relevance of a query result relative to other displayed results. The visual appearance of the query results may be determined based on a distribution of scores associated with the query results. Generally, the more a particular score deviates from a chosen statistical measure (e.g., mean, median, mode, etc.), the more distinct the visual appearance of the associated query result is from the other results. In this way, unlike with previous techniques, query results are presented to a user in an intuitive way that allows the user to distinguish between highly relevant and less relevant results.

### BACKGROUND

Search engines and recommendation systems typically display relevant results in lists that contain references to resources in databases. For example, to generate a search result list for a given search query, a search engine typically determines a so-called relevance (e.g., a score) for every resource in a search database, and then compiles a sorted list with search results having the highest relevance at the top of that sorted list. This list, or a subset thereof, is returned to the user computing device for display as a result of the given search query.

A layout of a search result list on a user computing device generally uses relevancy of the search results to determine where to display a given search result of that list. Typically, the result with the highest relevance (e.g., based on a score) is displayed at the top of the page, and subsequent results follow below. Through this layout, the user can infer that a search result listed on top of another result has been given a higher relevance by the search engine for the given search query. However, from this layout alone, the user cannot determine how much more relevant a search result is compared to other search results in the list. This information is of value, though, since it allows the user, for example, to make a more informed decision on whether to open a resource.

### SUMMARY

The techniques introduced herein overcome the deficiencies and limitations of the prior art, at least in part, with a system and method for providing visualization of search results to give context as to how relevant a query result is relative to the other results. The techniques include receiving a query and generating a score for each of a plurality of results to the query. The techniques further include arranging the plurality of results based on the score for each of the plurality of results and applying a visualization to the plurality of results based on a score distribution. The techniques also include providing instructions to render the plurality of results with the visualization. The visualization provides visual cues, such as variation in color, typography (e.g., size, spacing, etc.), layout, etc., to indicate relevance of a result relative to other displayed results. The techniques may also include receiving a request to reorder the results based on criteria other than the score and providing instructions to render the plurality of reordered results while maintaining the visualization.

Other aspects include corresponding methods, systems, apparatuses, and computer program products for these and other innovative aspects.

The features and advantages described herein are not all-inclusive and many additional features and advantages will be apparent in view of the figures and description. Moreover, it should be noted that the language used in the specification has been principally selected for readability and instructional purposes and not to limit the scope of the techniques described.

### BRIEF DESCRIPTION OF THE DRAWINGS

The techniques introduced herein are illustrated by way of example, and not by way of limitation in the figures of the accompanying drawings in which like reference numerals are used to refer to similar elements.

FIG. 1 is an example of search results presented using visualizations to indicate a score for each result relative to the other results in a text list.

FIG. 2A is an example distribution of scores for search results.

FIG. 2B is an example layout of search results presented as tiles with the size and position of the tiles based on the score of each result relative to the distribution in FIG. 2A.

FIG. 3A is an example distribution of scores for search results that have a linearly decreasing score distribution.

FIG. 3B is an example layout of search results presented as tiles with the size and position of the tiles based on the score of each result relative to the distribution in FIG. 3A.

FIG. 4A is an example distribution of scores for search results that have a rapidly decreasing score distribution.

FIG. 4B is an example layout of search results presented as tiles with the size and position of the tiles based on the score of each result relative to the distribution in FIG. 4A.

FIG. 5A is an example distribution of scores for search results that have a score distribution with a sharp drop in the scores.

FIG. 5B is an example layout of search results presented as tiles with the size and position of the tiles based on the score of each result relative to the distribution in FIG. 5A.

FIG. 6A is an example distribution of scores for search results that have a score distribution with multiple sharp drops in the scores.

FIG. 6B is an example layout of search results presented as tiles with the size and position of the tiles based on the score of each result relative to the distribution in FIG. 6A.

FIG. 7A is an example distribution of scores for search results that have a score distribution with multiple sharp drops in the scores.

FIG. 7B is an example layout of search results presented as tiles with the size of the tiles based on the score of each result relative to a statistical measure of the distribution of scores and the position of the tiles ordered according to criteria other than their scores.

FIG. 8 is an example of search results presented using visualizations to indicate a score for each result relative to the other results in a reordered text list.

FIG. 9 is a flow chart illustrating an example method for applying visualizations to search results.

FIG. 10 is a block diagram illustrating one embodiment of a computing device.

### DETAILED DESCRIPTION

While existing techniques for search engines and recommendations systems provide relevant results to users, the existing techniques fail to provide context as to how relevant a result is to the search query relative to the other results. In contrast, the disclosed techniques provide visual cues, such as variation in color, typography (e.g., size, spacing, etc.), layout, etc., to indicate relevance of a search result relative to other displayed results. Further, in addition to relevance, the visual cues, or visualizations, can advantageously provide an indication of popularity, recommendation value, or any other sorting criteria.

In at least some embodiments, the disclosed techniques include generating visualizations of the search results based on a distribution of scores associated with the search results. For example, the more a particular score deviates from a chosen statistical measure (e.g., mean, median, mode, high, low, etc.), the more distinct the visual appearance of the associated search result is presented or displayed with respect to the other results. In this way, unlike with previous techniques, search or recommendation results are presented to a user in an intuitive way that allows the user to distinguish between highly relevant and less relevant results.

In some embodiments, the techniques include providing a capability for a user to reorder the search results in accordance to different criteria while maintaining the visual appearance associated with the score of each search result. That is, each search result can have a distinct visual appearance relative to other search results, which indicates each the relative score of each result, while at the same time allowing the user to define how results are ordered. For example, search results having a relevance score that indicates how closely the search result matches a first criterion in the user's query may be re-sorted using a second criterion (e.g., date, alphabetical order, author, etc.). That is, upon user input of the second criterion, the disclosed techniques include generating, by the search engine or a local system plug-in, an updated visualization that maintains the visual appearance of search results according to the first criterion while ordering the results according to the second criterion.

In one embodiment, the techniques include generating search results for display (e.g., by a user computing device) in a list as text-only results with variation in font size, font color, spacing between results, etc. to indicate relative scores for the search results. In other embodiments, the techniques includes generating (e.g., by a search/recommendation engine, a user computing device, or the like) visualizations that display the search results as tiles, charts, word clouds, graphs, or the like, with the size, shape, and/or color of the elements to correspond to search results that vary based on relative scores of the results. Regardless of how a search or recommendation provider chooses to display search results to a user (e.g., in a chart, as text-only results, as tiles, etc.), the techniques disclosed herein provide the capability to generate visualizations that indicate relative scores between search results.

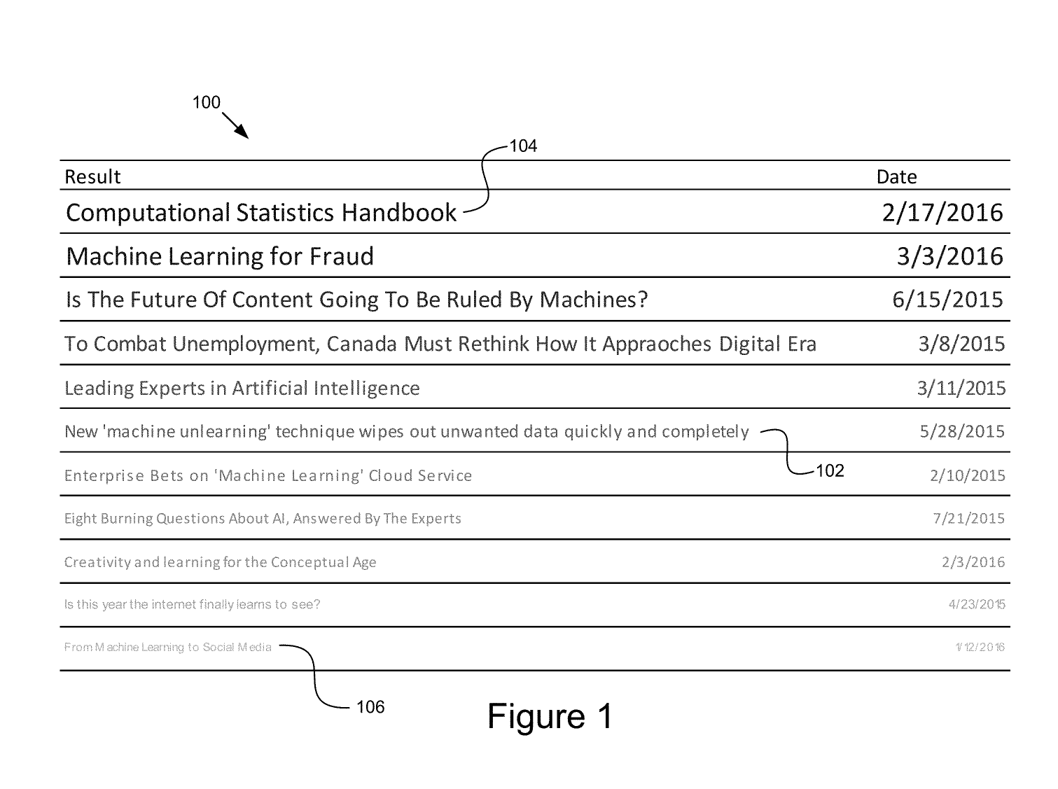

FIG. 1 is an example of search results presented using visualizations to indicate a relevance (e.g., based on a score) of each result relative to the other results in a text list. A search or recommendation engine may generate the results in the example of FIG. 1. For example, to generate the list, the search or recommendation engine determines a score (e.g., relevancy score indicating relevance between a search query and a search result, recommendation score based on past user interaction, popularity score based on interactions with an item, or the like) that indicates how closely an item in the search database matches the terms of a search query from a user.

As shown in the example of FIG. 1, the search results are presented as a text list 100 of file names and other identifying information. Typically, such a list would be sorted based on a score associated with each result (e.g., relevancy score indicating relevance between a search query and a search result, recommendation score based on past user interaction, popularity score based on interactions with an item, or the like), with no indication of how the result having one score compares to another result having another score in the text list 100. However, in accordance with the disclosed techniques, the search results presented in the example of FIG. 1 include visualizations that indicate a given result's score relative to the corresponding scores of other results. In this example, visualization for a given result includes variation in font size and color to indicate whether that result has a higher or lower score than other results.

In one embodiment, the techniques include applying visualizations to the search results of the text list 100 based on a statistical measure of the scores. For example, the more a particular score deviates from a chosen statistical measure, the more distinct the visual appearance of the associated search result is from the other results. In some embodiments, the chosen statistical measure may be a centrality of scores (e.g., mean, mode, median, etc.). In other embodiments, the chosen statistical measure may be a maximum score, a minimum score, a range of the scores, percentile, etc.

The example list in FIG. 1 depicts visualization applied based on a mean score for the results in the text list. Note that the techniques various statistical measures may be used to determine visualizations other than the “mean.” In one embodiment, a base font size (e.g., 10) and base font color (e.g., grey (#808080)) are determined for use in applying the visualizations to the search results. In such embodiment, the techniques include displaying a search result having a score equal to the chosen statistical measure (e.g., mode, median, maximum, minimum, etc.), for example, using the base font color of “grey” and base font size of “10”. In some embodiments, the search results do not include a result with a score that is equal to the statistical measure used to apply the visualization. In such embodiments, no results are displayed using the base font size and font color. The techniques in such embodiments include, generating a font size and font color for each result that are a function of the score of the result and the chosen statistical measure.

In the example of FIG. 1, the techniques include using a base font size and font color for a search result having a score equal to the mean score. For example, assuming the score for result 102 is equal to the mean score, the techniques include displaying the result 102 with the base font color and font size. The font size and font color of the remaining results in the text list 100 are a function of the mean score. That is, how much a given result's score differs from the mean score determines how different the visualization applied to the given result is from the visualization applied to a result having the mean score. As shown in the example of FIG. 1, the techniques include generating a visualization with a darker font color and larger font size, to indicate a higher relative score) for each of the remaining results that has a score higher than the mean score of result. For example, the result 104 has the highest score and is darker and larger than the other results in the list. Similarly, the techniques include generating a visualization with a lighter font color and smaller font size, to indicate a lower relative score, for each of the remaining results that has a lower score than the mean score of result 102. For example, the result 106 has the lightest font color and smallest font size because the result 106 has the lowest score relative to the other results in the list.

In various embodiments, the techniques include generating the font color and font size of a given result provided in a text list (e.g., the text list 100 shown in the example of FIG. 1) by taking into consideration the score of the result, the base font size, the base font color, and/or the chosen statistical measure. In one embodiment, the techniques include determining font size and font color according to the following equations:

$$fontsize = basefontsize + \frac{entryscore - meanscore}{meanscore}$$

$$fontcolor = round ( basecolor - 10 * \frac{entryscore - meanscore}{meanscore} )$$

In the fontsize equation above, basefontsize is the font size of a result that has a score equal to the mean score, entryscore is the score of a given result, and meanscore is the mean score of all displayed or returned results. Thus, the techniques include taking into account the base font size, the score of a given result, and the chosen statistical measure when determining a visualization to apply to the given result. Similarly, in the fontcolor equation above, basecolor is the font color of a result that has a score equal to the mean score, entryscore is the score of a given result, and meanscore is the mean score of all displayed or returned results. Additionally, the calculation may be rounded (e.g., as indicated by the round(x) function) to generate whole numbers that correspond to defined colors (e.g., HTML defined colors). Further, a multiplier (e.g., 10) may be included to increase or decrease the spread of the colors (or font size) from the base font color (or base font size).

In some embodiments, the techniques include providing a capability for a user to configure, or choose, (e.g., via user input) the base font size and base font color. In other embodiments, the techniques include predetermining or pre-configuring the base font size and the base font color by using the result scores or distribution of result scores. For example, the techniques may use a defined base font size and base font color to generate a font size and font color for all results. Alternatively, the techniques may include selecting a base font size and base font color (e.g., from a range of base font sizes and base font colors) by considering the distribution of scores and the number of results. In some embodiments, the techniques including limiting, or bounding, the font size to a range around the base font size to prevent the results from being displayed too large (e.g., taking up too much space on a display) or small (e.g., too small to be legible). For example, if the base font size is 12 point, the font size for results are bounded to between 8 pt. and 16 pt. font and any result that has a calculated font size that falls outside of this range will be limited to avoid the problems described above. In other embodiments, the font size is unbounded and search results can be infinitely large or small based on variance from the statistical measure. In some embodiments, the techniques include limiting the font size to whole number values (e.g., 8 pt., 9 pt., 10 pt., etc.) to accommodate computing systems that do not allow fractional font sizes. In some embodiments, the techniques include communicating relative score of results that are the same size (e.g., fall outside the bounded range and therefore displayed at the maximum or minimum size) to users by variation in the font color.

Similarly, in some embodiments, the techniques include limiting the font color to a range (e.g., [#101010, #999999]) to prevent displaying search results in a color that is too light for a user to discern. In one embodiment, the techniques include determining font color by concatenating the computed font color integer (from the equation above) three times, preceded by a # to generate a hexadecimal color value. The equations above are used as an example and it should be apparent that other equations based on deviation from a statistical measure of scores may be used without departing from the techniques described herein.

In addition to variation in font size and font color, in one embodiment, the techniques include adjusting the space between results in a list (e.g., increasing or decreasing space between results) based on the variance in scores of the results. For example, in one embodiment, the techniques include determining the space between two results by taking into consideration the respective scores of the two results (e.g., computing a difference of the result scores). In another embodiment, the techniques include determining the space between two results by taking into consideration the respective scores and the statistical measure used to apply visualizations to the results.

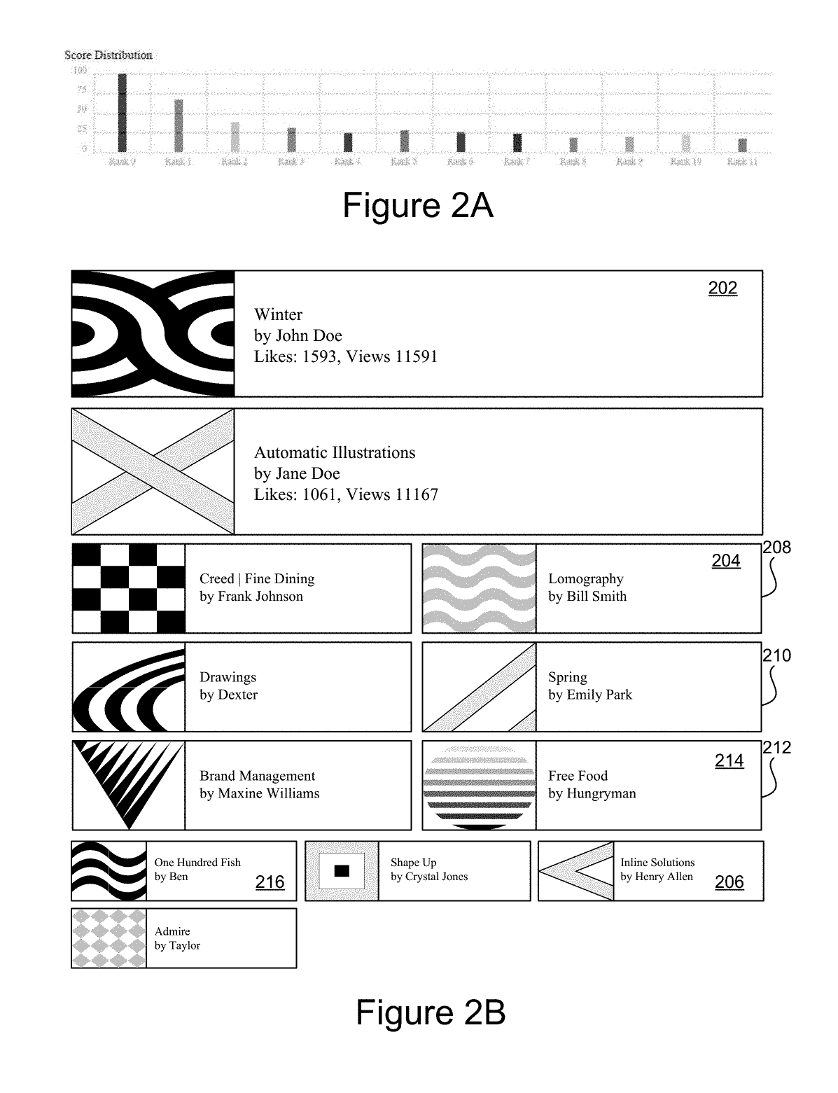

As described above, the visual appearance of each search result is discrete based on variation of the score associated with each result from the chosen statistical measure. In some embodiments, the visualization applied to the search results does not lead to search results displayed with a continuum of discrete appearances. For example, in one embodiment, the techniques include clustering search results into groups based on the chosen statistical measure (e.g., based on one or more thresholds) and a common visualization is applied to the search results belonging to each group. This may be particularly applicable to search results provided as tiles, charts, word clouds, etc. In such examples, a continuum of discrete sizes and/or shapes would make the results difficult to efficiently display to a user. Variations on grouping of search results and applying common visualizations to search results in a group in accordance with various embodiments of the disclosed techniques are depicted below with reference to FIGS. 2-7.

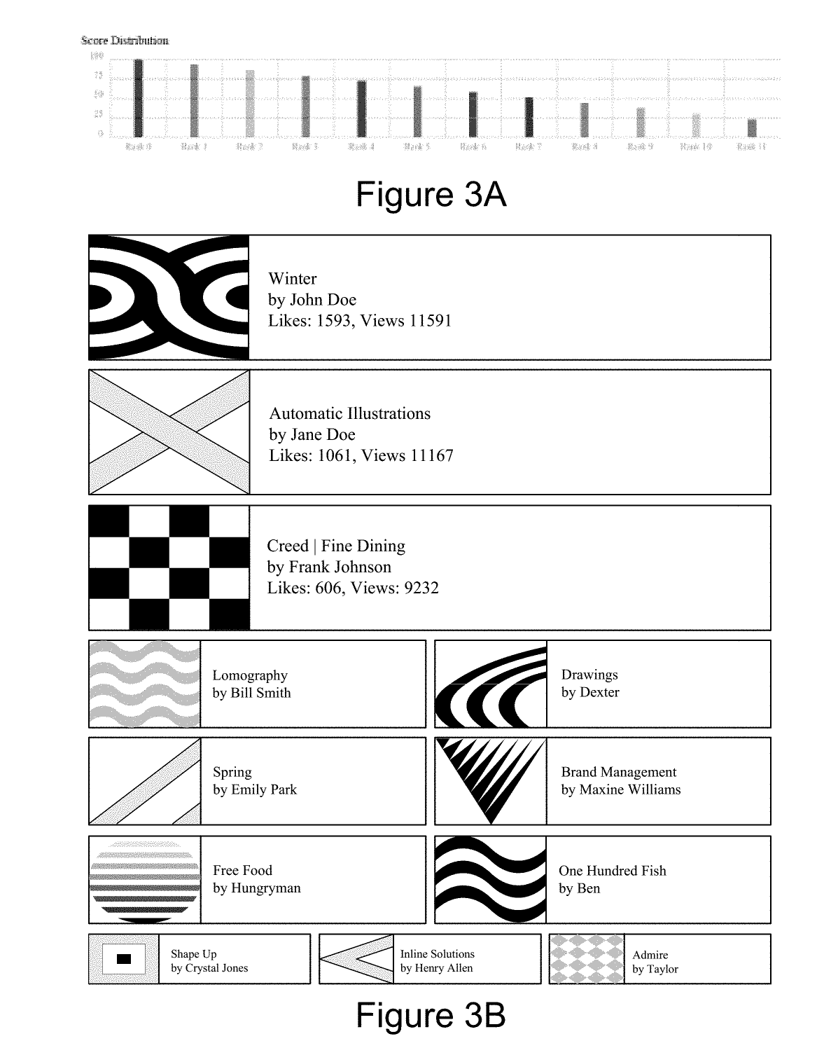

FIG. 2A is an example distribution of scores for search results. The example distribution of scores in FIG. 2A depicts a distribution that may be typical of common search results. In the example of FIG. 2A, a higher score is depicted by a taller bar in the graph. FIG. 2B is an example layout of search results presented as tiles with the size and position of the tiles based on the score of each result relative to the distribution. While the search results in the example of FIG. 2B (and FIGS. 3-7B below) are depicted as tiles, other visualizations are equally applicable and can be determined by a search result provider or a search interface designer. For example, the techniques may include using other bounding regions besides tiles (e.g., segments of a chart, etc.) to display results belonging to a group. Further, the techniques include applying a similar visualization to a text list of results, where a common font size and/or font color are applied to a group of results. In one embodiment, the techniques include applying a common font size to a group while indicating variation of scores within the group by a variation on font color. In another embodiment, the techniques include applying a common font color to a group of search results while indicating variation of scores within the group by a variation in font size.

Returning to the example of FIG. 2B, as described above, a statistical measure (e.g., mean) of the distribution is selected for applying visualizations to the search results. The techniques include determining size and position of the tiles in the search result layout based on the statistical measure and the scores of the search results displayed in the tiles. For example, as shown in FIG. 2B, three tile sizes are used to display search results. The techniques include grouping search results into three groups based on the scores associated with each search result and the chosen statistical measure. For example, using the mean as the chosen statistical measure, two thresholds are determined on either side of the mean. The scores above the higher threshold are clustered in a first group, scores between the two thresholds are clustered in a second group, and scores below the lower threshold are clustered in a third group.

The results having scores that fall in the second group (e.g., scores between the two thresholds and closest to the mean) are displayed as medium sized tiles. To sufficiently differentiate between large, medium, and small tiles, as well as efficiently use display space, the techniques include displaying medium tiles across half the width of the screen, such as tile 204. The results having scores that fall in the first group (e.g., scores above the high threshold) are displayed as large tiles (e.g., the full width of the screen, such as tile 202). The results having scores that fall below the low threshold are displayed as small tiles (e.g., one third the width of the screen, such as tile 206). While the tiles in the examples herein are depicted as the width of the display, one-half the width of the display, and one-third the width of the display, other distributions of space can be used.

As described above, the tile size for a search result is determined based on the variance of the result score from the chosen statistical measure. For example, in the embodiment described above with three distinct size tiles, large tiles are used for search results that have a score greater than four-thirds of the mean score, small tiles are used for those search results that have a score less than two-thirds of the mean score, and medium tiles are used for the remaining search results (i.e., search results that have a score between the high threshold of four-thirds of the mean score and the low threshold of two-thirds of the mean score). To fit the maximum number of search results on a page displayed to a user, the number of search results to be displayed using a particular tile size is chosen such that horizontal white space on the screen (e.g., white space to the right or left of a search result) is filled before changing sizes. In one embodiment, the disclosed techniques include promoting tiles in size to fill the remaining white space in a larger tile group. In another embodiment, the disclosed techniques include demoting tiles in size to eliminate extra tiles in a size group. For example, referring to the example of FIG. 2B, assume that there are originally five search results in the group to be displayed with the medium tile size based on their scores. Based on this number, there would be two full rows of tiles (e.g., rows 208 and 210) and one partial row of tiles (e.g., row 212). To efficiently use the white space, tile 214 is promoted from the small tile group and displayed to the user as a medium tile. In an example embodiment, assume that there are seven search results in the medium tile group based on the result scores. Based on this number, there would be three full rows of tiles (e.g., rows 208, 210, and 212) and one partial row of tiles (not shown). To efficiently use the white space (e.g., white space to the right of the partial row of tiles), tile 216 is demoted to the small tile group and displayed at one-third the width of the display. Thus, tiles are moved between groups such that the space is efficiently used.

FIG. 3A is an example distribution of scores for search results that have a linearly decreasing score distribution. The score distribution depicted in the example of FIG. 3A (and generally those in FIGS. 3A-7A) is used to show how grouping and display of search results may differ based on the distribution of scores. FIG. 3B is an example layout of search results presented as tiles with the size and position of the tiles based on the score of each result relative to the distribution in FIG. 3A. As can be seen when comparing FIGS. 2B and 3B, the difference in score distribution results in the visualization of the tiles being presented differently to the user. Advantageously, a user reviewing the search results as presented in the example of FIG. 3B may quickly determine, based on appearance of the tiles, that the scores of the results are fairly evenly distributed with not much variation from the mean.

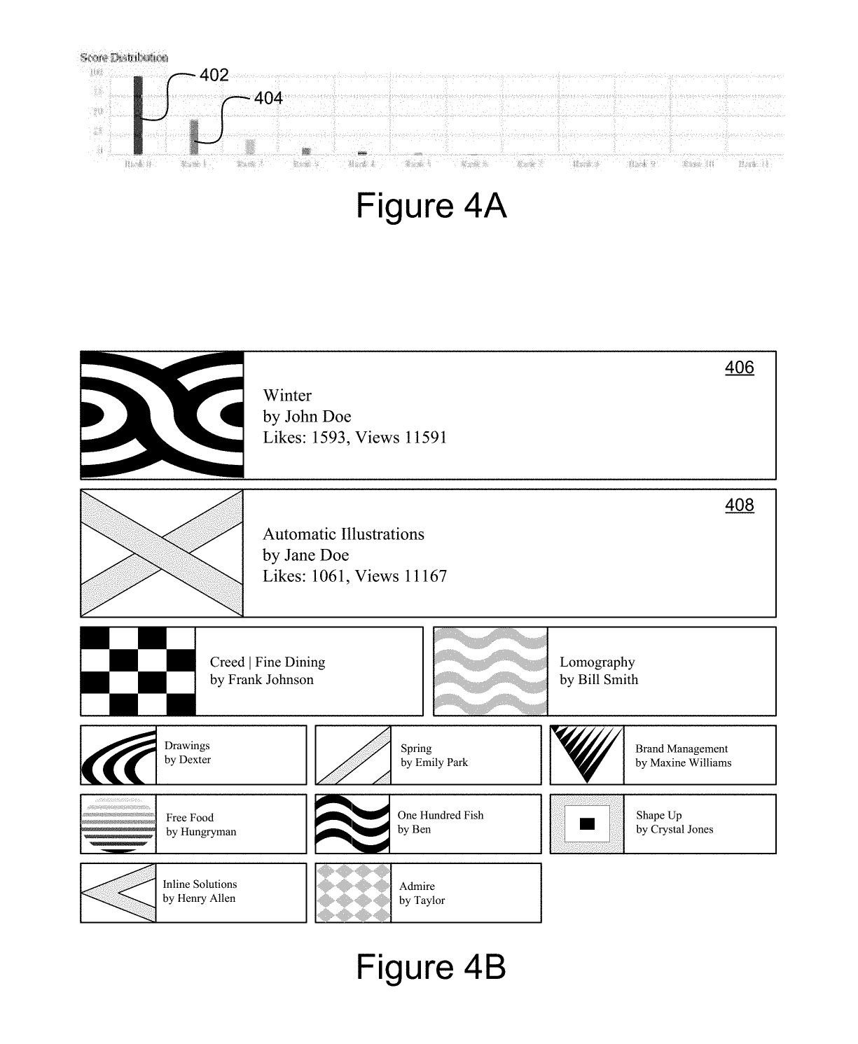

FIG. 4A is an example distribution of scores for search results that have a rapidly decreasing score distribution. The score distribution in the example of FIG. 4A is representative of the typical search result where there is one or two high-scoring results (e.g., results 402 and 404) and the remaining results have relatively low scores. This score distribution is likely to emerge when a user provides a narrow search query or few relevant results are available. FIG. 4B is an example layout of search results presented as tiles with the size and position of the tiles based on the score of each result relative to the distribution in FIG. 4A. As shown in FIG. 4B, the high-scoring results 402 and 404 are presented as large tiles 406 and 408, respectively. In one embodiment, more information is provided with search results having a higher score. For example, results 406 and 408 are displayed with additional information (e.g., the number of “likes” and “views” the result has received). Additionally, the font size and/or font color associated with the tile may vary as described above to further indicate the score of a search result. For example, the techniques include communicating the difference in score between results 406 and 408 to the user by varying the font size and/or font color even though the tiles remain the same size. In one embodiment, the statistical measure used to determine the font size and/or font color is different from the statistical measure used to group the search results. Returning to the example of FIG. 4B, and referring to the score distribution depicted in FIG. 4A, two results have scores near the mean and are presented as medium tiles. Because the scores of the remaining results are small and do not contribute significantly to the mean score, the scores fall below the low threshold and are presented as small tiles.

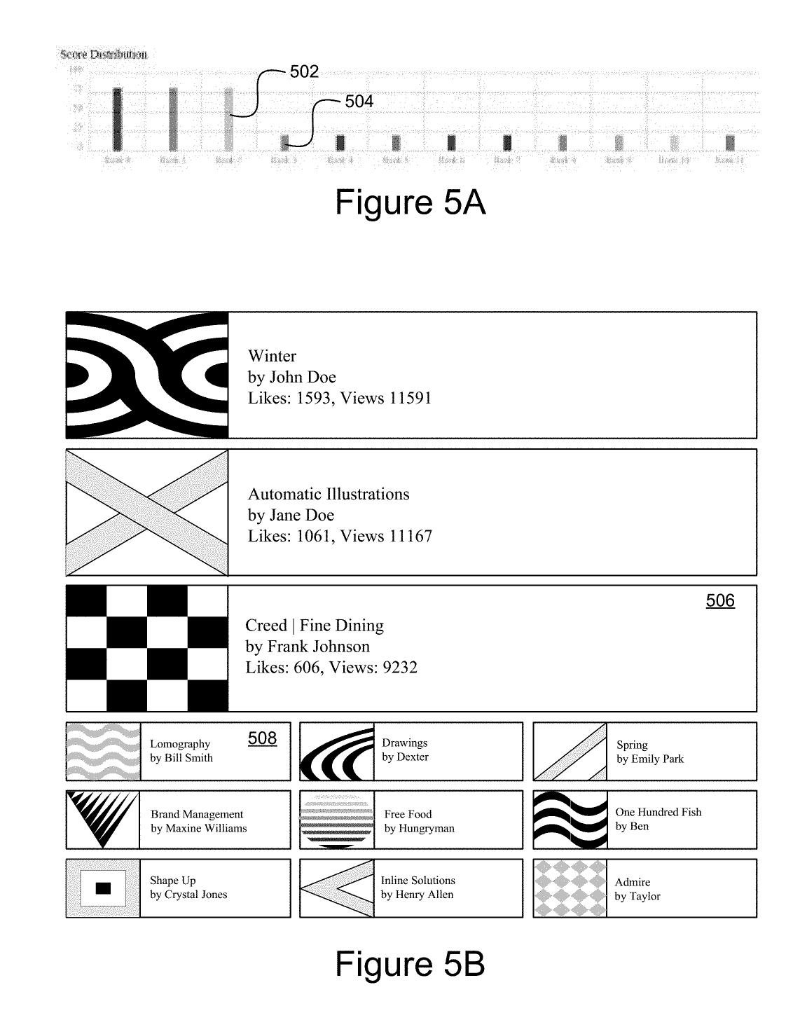

FIG. 5A is an example distribution of scores for search results that have a score distribution with a sharp drop in the scores. As shown in FIG. 5A, there is a sharp drop between score 502 and score 504. This sharp drop from one score to the next may be referred to herein as an elbow. The scores on either side of this elbow are relatively similar to other scores on their respective side. FIG. 5B is an example layout of search results presented as tiles with the size and position of the tiles based on the score of each result relative to a statistical measure (e.g., mean) of the distribution in FIG. 5A. As shown in FIG. 5B, the results before the elbow are presented as large tiles with the score 502 corresponding to tile 506 and the results after the elbow are presented as small tiles with the score 504 corresponding to tile 508. Because there is a large difference between the scores on either side of the elbow, the medium sized tiles are omitted as shown in FIG. 5B. Omitting the medium size tiles, emphasizes the large difference in score at the elbow and the relative similarity of scores on either side of the elbow.

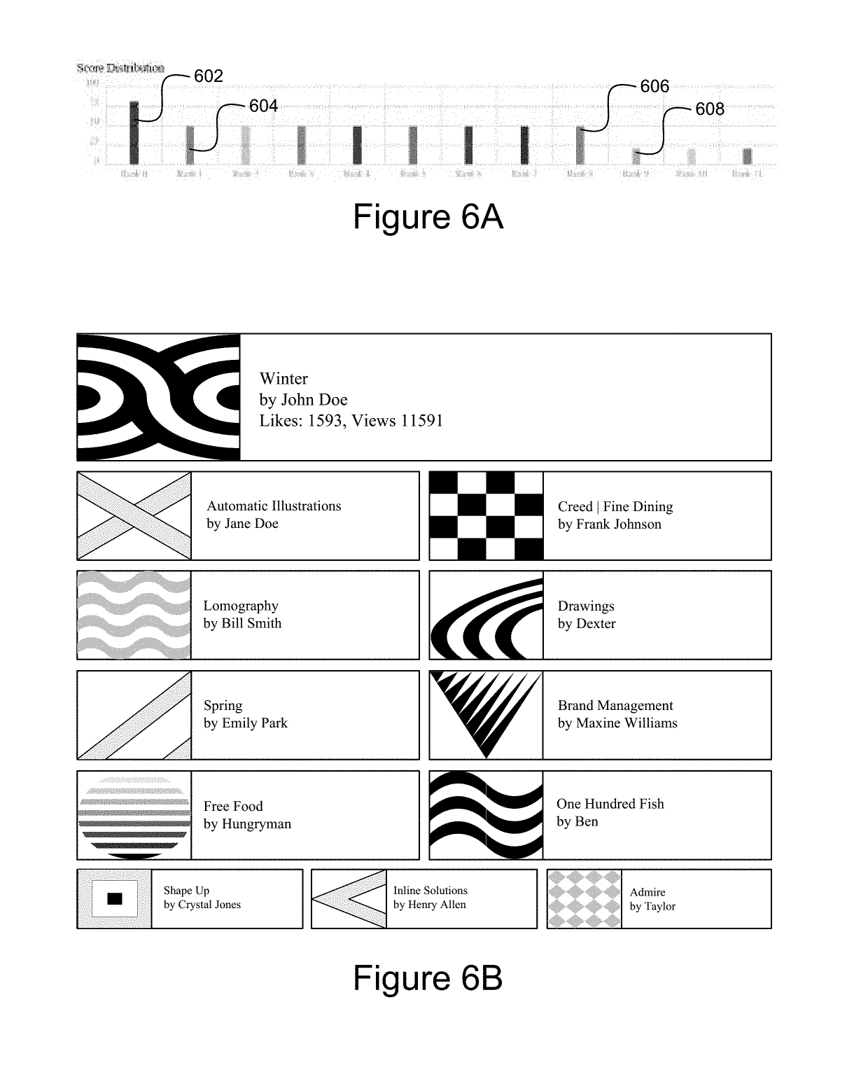

FIG. 6A is an example distribution of scores for search results that have a score distribution with multiple sharp drops in the scores. As shown in FIG. 6A, there is a drop between score 602 and score 604 and another drop between score 606 and score 608. The scores between 604 and 606 are relatively similar to other scores in this range and the scores after 608 are relatively similar to the score 608. FIG. 6B is an example layout of search results presented as tiles with the size and position of the tiles based on the score of each result relative to a statistical measure of the distribution in FIG. 6A. As shown in FIG. 6B, the results before the first elbow (i.e., score 602) are presented as large tiles, the results between the first elbow and the second elbow (i.e., between score 604 and score 606) are presented as medium tiles, and the scores after the second elbow are presented as small tiles.

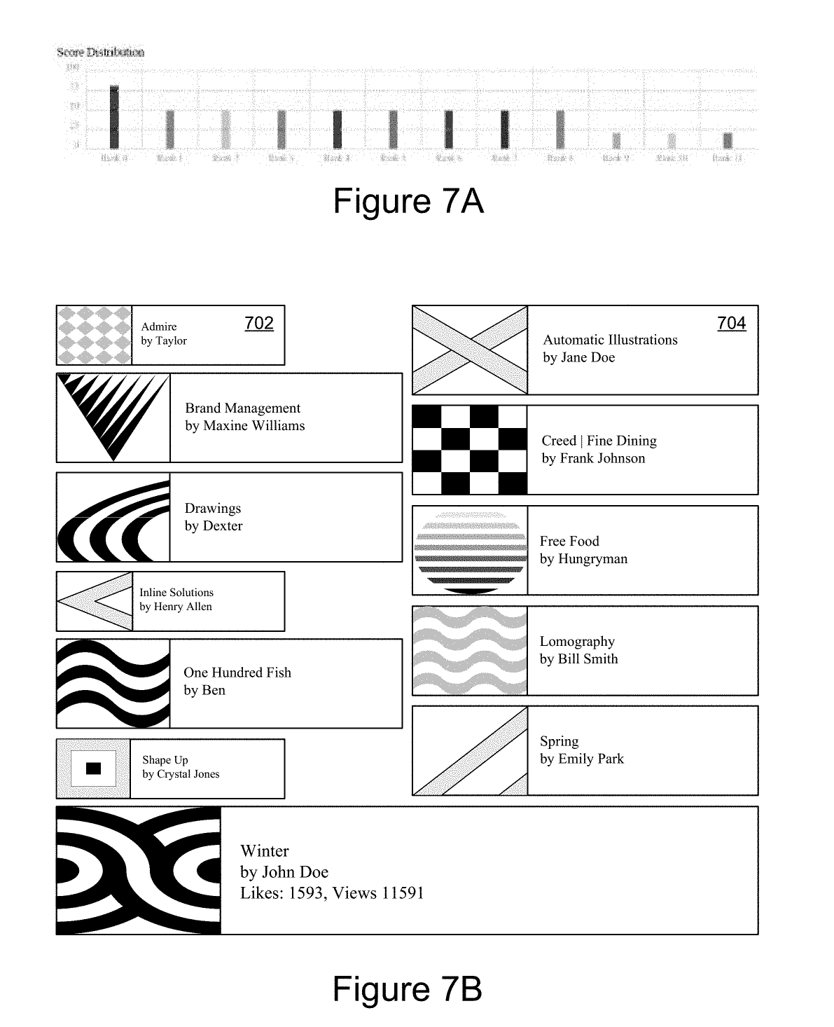

FIG. 7A is an example distribution of scores for search results that have a score distribution with multiple sharp drops in the scores, similar to the scores described above with reference to FIG. 6A. FIG. 7B is an example layout of search results presented as tiles with the size of the tiles based on the score of each result relative to a statistical measure of the distribution depicted in FIG. 7A and the position of the tiles ordered according to criteria other than their scores. I many instances, a user sorts search results according to criteria other than score (e.g., date, title, author, source, popularity, or other metrics associated with the search results). In a typical display of search results, where all results appear with the same visualization, relative score (e.g., relevance difference between results) is lost when results are reordered. However, as shown in the example of FIG. 7B, even though the results are sorted in alphabetical order, relative score is still be easily determined based on the tile size of the result. For example, while tile 702 is listed as the first result due to sorting based on name, a user viewing the search results provided in FIG. 7B can see that the result is relatively less relevant to his search query than the result provided in tile 704.

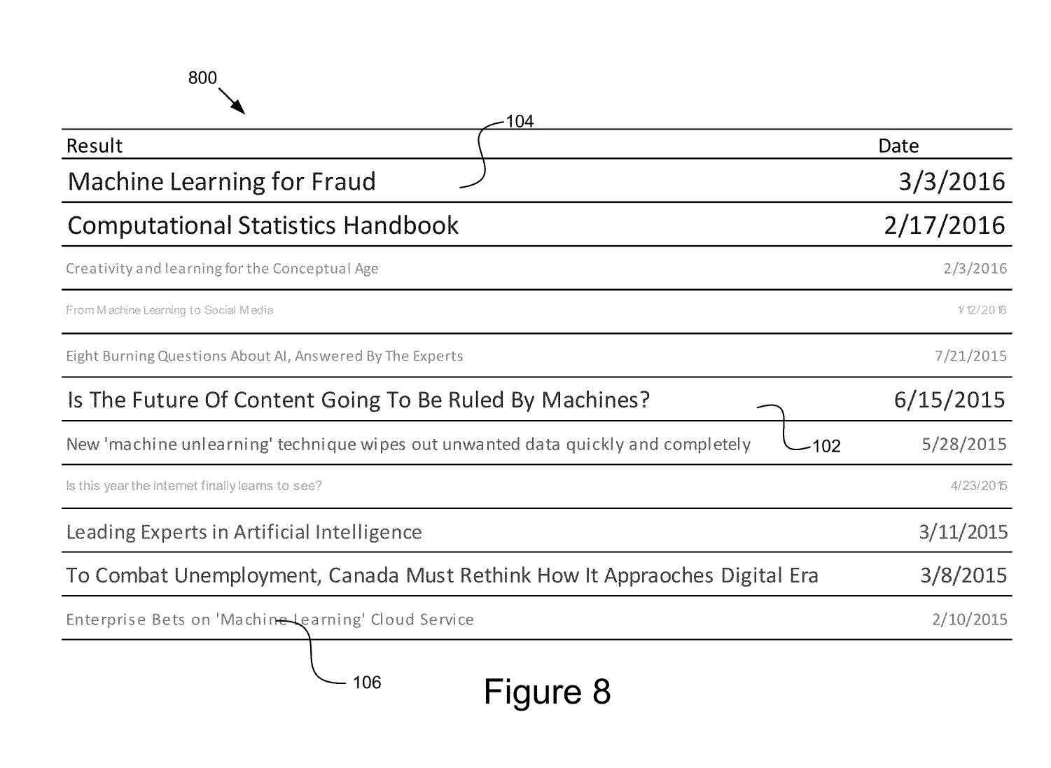

FIG. 8 is an example of search results presented using visualizations to indicate a score for each result relative to the other results in a reordered text list. In the illustrated embodiment, the font size and font color of the search results indicate relative scores as described above with reference to FIG. 1. However, in the example of FIG. 8, the scores are reordered (e.g., in response to user input) according to a date (newest to oldest) associated with the result (e.g., a document creation or modification date, a publication date, etc.). Because the search results maintain their visualization to indicate relative score, it is easy for a user to view the results and identify which results are more relevant to her search query regardless of the order that the results are displayed in. In some embodiments, some search results are omitted from the display to the user based on filters applied to the search results without affecting the visualizations applied to the results.

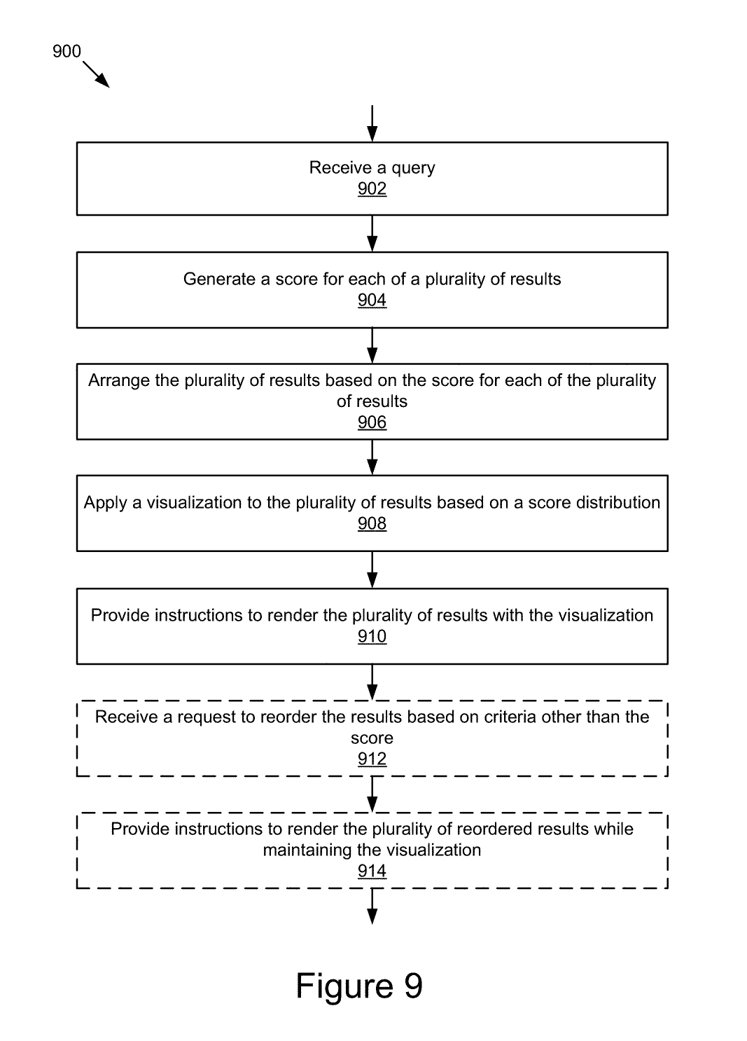

FIG. 9 is a flow chart illustrating an example method 900 for applying visualizations to search results. In some embodiments, the method 900 is executed/performed by a computing system as discussed below (e.g., system 1000. In some embodiments, the system is a server, cloud computing system, or the like, that provides search and or recommendations to a user based on a search query. In other embodiments, the system is a user computing system that receives search and/or recommendation results from a third party system. At 902, the system receives a search query. In one embodiment, the query may be a query for results based on keywords. In other embodiments, the query may be a query for recommendations based on historical user information. At 904, the system generates a score for each of a plurality of results to the query. In some embodiments, the computing system generates the score to represent how closely a search results matches the criteria in the query and to indicate relevance, popularity, etc. In one embodiment, the system generates the score as a recommendation score based on the search query and past user interaction with the system. At 906, the system arranges plurality of results based on the score for each of the plurality of results.

At 908, the system applies a visualization to the plurality of results based on a score distribution and, at 910, the system provides instructions to render the plurality of results with the visualization applied. In some embodiments, providing instructions to render the plurality of results with the visualization includes communicating or transmitting information (e.g., computer programmable instructions) to a computing device to cause the device to display the search results (e.g., on a display device of the computing device). For example, in one embodiment, a search engine provides an HTML document to a browser with visualizations already applied to the search results. The HTML document can include code (e.g., using JavaScript®, or the like) to apply visualizations to search results dynamically. In another embodiment, the disclosed techniques are embodied in a web-based plug-in or add-in that applies visualizations to search results. In such embodiment, for example, a user's web browser includes the add-in or plug-in, and can generate the visualizations to search results provided to the user's computing device (e.g., as and HTML document, XML document, or the like) by a search or recommendation engine according to the techniques described herein.

As described above, the visualization that is applied to the plurality of results provides visual cues, such as variation in color, typography (e.g., size, spacing, etc.), layout, etc. to indicate a score of a result relative to other displayed results. The visual appearance of the results is determined based on a distribution of scores associated with the search results. For example, the more a particular score deviates from a chosen statistical measure (e.g., mean, median, mode, etc.), the more distinct the visual appearance of the associated search results is from a result near the chosen statistical measure. In this way, unlike with previous techniques, search or recommendation results are presented to a user in an way that allows the user to quickly and intuitively distinguish between highly relevant and less relevant results.

At 912, the system may optionally receive a request to reorder the results based on criteria other than the score and, at 914, provide instructions to render the plurality of reordered results while maintaining the visualization applied at 208. For example, based on user input to reorder the results after the search results have been provided, the results are reordered based on date, author, publisher, source, time, or other criteria that the user has selected to distinguish one result from another. However, while the results are reordered according to this additional criteria selected by the user, the visualization applied to the results based on the score is maintained. Thus, a user can still quickly and intuitively determine how the score of a particular result compares to other results after the reordering.

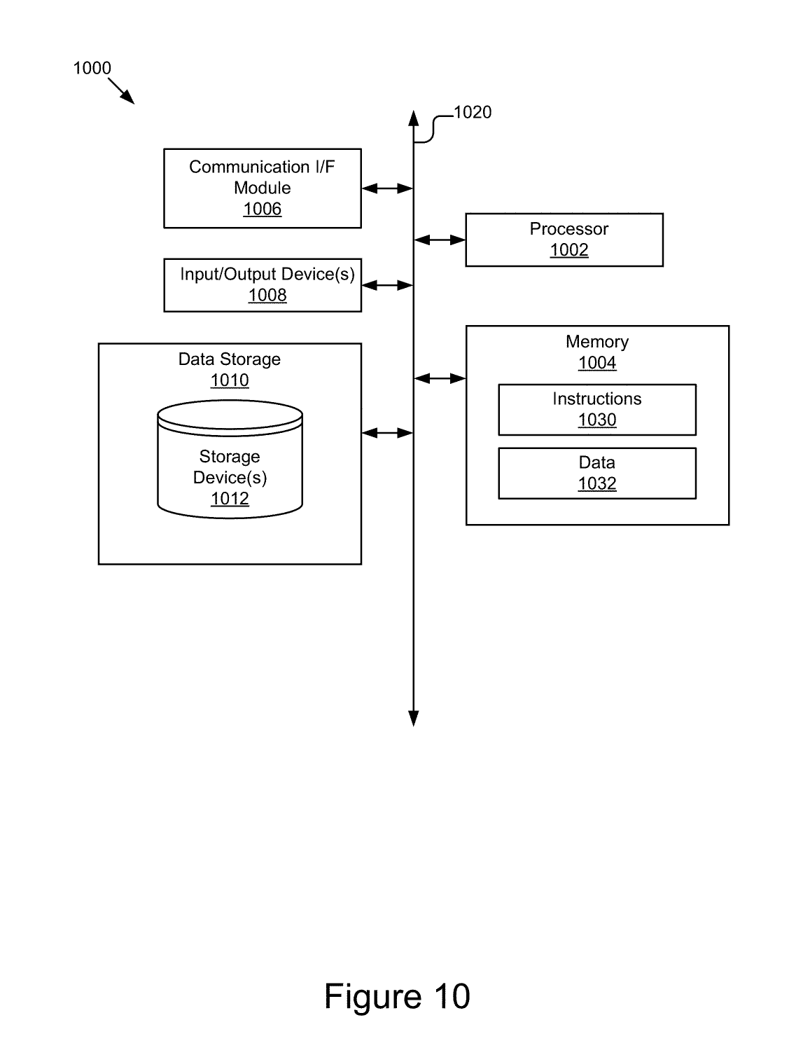

Any suitable computing system or group of computing systems can be used to implement the techniques and methods described herein. For example, as described above, a search or recommendation engine generates search results and scores, applies visualizations to the search results based one the scores, and provides the search results to a user's computer for display to the user with the visualizations. FIG. 10 is a block diagram illustrating one embodiment of a computing device (e.g., search engine server, cloud computing system, etc.) 1000 suitable for implementing the techniques and methods described herein. The computing device 1000 may include a processor 1002, a memory 1004, a communication interface module 1006, input/output device(s) 1008, and data storage 1010 according to some examples. The components of the computing device 1000 are communicatively coupled by a bus or software communication mechanism 1020. The bus 1020 may represent one or more buses including an industry standard architecture (ISA) bus, a peripheral component interconnect (PCI) bus, a universal serial bus (USB), or some other bus known in the art to provide similar functionality.

The processor 1002 may execute software instructions by performing various input/output, logical, and/or mathematical operations. The processor 1002 may be physical and/or virtual, and may include a single processing unit or a plurality of processing units and/or cores. The processor 1002 may comprise a microprocessor, an application specific integrated circuit, a state machine, or other processing device. In some implementations, the processor 1002 may be coupled to the memory 1004 via the bus 1020 to access data and instructions therefrom and store data therein. The bus 1020 may couple the processor 1002 to the other components of the computing device 1000 including, for example, the memory 1004, the communication interface module 1006, and the data storage 1010. It will be apparent that other processors, operating systems, sensors, displays, and physical configurations are possible.

The memory 1004 may store and provide access to data for the other components of the computing device 1000. The memory 1004 may be included in a single computing device or distributed among a plurality of computing devices. In some implementations, the memory 1004 may store instructions 1030 that may be executed by the processor 1002 and/or data 1032 that may be manipulated by the processor 1002. The instructions 1030 may include code for performing the techniques described herein. The memory 1004 is also capable of storing other instructions and data, including, for example, an operating system, hardware drivers, other software applications, databases, etc. The memory 1004 may be coupled to the bus 1020 for communication with the processor 1002 and the other components of the computing device 1000.

The memory 1004 may include one or more non-transitory computer-usable (e.g., readable, writeable) devices, for example, a dynamic random access memory (DRAM) device, a static random access memory (SRAM) device, an embedded memory device, a discrete memory device (e.g., a PROM, EPROM, ROM), a hard disk drive, an optical disk drive (e.g., CD, DVD), or the like, which can be any tangible apparatus or device that can contains, stores, communicates, or transports instructions, data, computer programs, software, code, routines, etc., for processing by, or in connection with, the processor 1002. In some implementations, the memory 1004 may include one or more of volatile memory and non-volatile memory. It should be understood that the memory 1004 may be a single device or may include multiple types of devices and configurations.

The communication interface module 1006 is hardware and/or software for receiving and transmitting data by linking the processor 1002 to a network or other processing systems. The communication interface module 1006 may receive data and/or instructions and transmit the data and/or instructions to the processor 1002 for execution. In one embodiment, the communication interface module 1006 may include a port for direct physical connection to a communication channel. The communication interface module 1006 may also or alternatively include a wireless transceiver for transmitting and receiving instructions and/or data using one or more wireless communication methods, such as IEEE 802.11, IEEE 802.16, Bluetooth®, or another suitable wireless communication method.

The input/output device(s) 1008 may be internal or external devices that facilitate communication between the computing device 1000 and a human user. For example, the input/output devices may include a keyboard, display, microphone, speakers, etc.

The data storage 1010 may include storage device(s) 1012 that provide a non-transitory memory to store data for providing the functionality described herein. In some embodiments, the storage device(s) 1012 may include a non-volatile memory or similar permanent storage device and media including a hard disk drive, a floppy disk drive, a CD-ROM device, a DVD-ROM device, a DVD-RAM device, a DVD-RW device, a flash memory device, or some other mass storage device for storing information.

In the above description, for purposes of explanation, numerous specific details are set forth in order to provide a thorough understanding of the techniques introduced above. It will be apparent, however, to one skilled in the art that the techniques can be practiced without these specific details. In other instances, structures and devices are shown in block diagram form in order to avoid obscuring the description and for ease of understanding.

Reference in the specification to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

The foregoing description of the embodiments has been presented for the purposes of illustration and description. It is not intended to be exhaustive or to limit the specification to the precise form disclosed. Many modifications and variations are possible in light of the above teaching. It is intended that the scope of the embodiments be limited not by this detailed description, but rather by the claims of this application. As will be understood by those familiar with the art, the examples may be embodied in other specific forms without departing from the spirit or essential characteristics thereof. Likewise, the particular naming and division of the modules, routines, features, attributes, methodologies and other aspects are not mandatory or significant, and the mechanisms that implement the description or its features may have different names, divisions and/or formats. Furthermore, as will be apparent to one of ordinary skill in the relevant art, the modules, routines, features, attributes, methodologies and other aspects of the specification can be implemented as software, hardware, firmware or any combination of the three. Also, wherever a component, an example of which is a module, of the specification is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming. Additionally, the specification is in no way limited to embodiment in any specific programming language, or for any specific operating system or environment. Accordingly, the disclosure is intended to be illustrative, but not limiting, of the scope of the specification, which is set forth in the following claims.

What is claimed is:

1. A method for visually indicating relative score of query results to a user, the method comprising:
receiving a search query from the user;
responsive to the search query, ordering a plurality of search results, returned based on the search query, according to a score for each of the plurality of search results;
applying a visualization to the plurality of search results based on a distribution of scores associated with the plurality of search results; and
generating instructions to render the plurality of search results with the visualization.

2. The method of claim 1, further comprising:
receiving a request to reorder the plurality of search results based on a criterion other than the score for each of the plurality of search results; and
providing instructions to render the plurality of reordered results while maintaining the visualization.

3. The method of claim 1, wherein applying the visualization to the plurality of search results based on the distribution of scores associated with the plurality of search results comprises:
identifying a statistical measure of the distribution of scores associated with the plurality of search results; and
determining the visualization to apply to each of the plurality of search results based on the statistical measure.

4. The method of claim 3, wherein determining the visualization to apply to each of the plurality of search results based on the statistical measure comprises:
determining a font size using a base font size, a result score, and the statistical measure; and
determining a font color using a base font color, the result score, and the statistical measure.

5. The method of claim 4, wherein the statistical measure is a statistical centrality measure and the base font size corresponds to a given search result having a given score equal to the statistical centrality measure.

6. The method of claim 4, wherein the statistical measure is a statistical centrality measure and the base font color corresponds to a given search result having a given score equal to the statistical centrality measure.

7. The method of claim 1, further comprising:
clustering the plurality of search results based on the distribution of scores associated with the plurality of search results; and
applying the visualization to the plurality of search results based on the clustering.

8. A system comprising;
one or more processors; and
a memory, the memory storing instructions, which when executed cause the one or more processors to:
receive a query;
generate a score for each of a plurality of results to the query;
cluster the plurality of results into a plurality of clusters based on a deviation from a statistical measure of a distribution of scores associated with the plurality of results;
arrange the plurality of clusters based on the deviation from the statistical measure of the distribution of scores associated with the plurality of results;
apply a visualization to the plurality of results based on the plurality of clusters; and
provide instructions to render the plurality of results with the visualization.

9. The system of claim 8, wherein the instructions further cause the one or more processors to:
receive a request to reorder the results based on a criterion other than the scores associated with the plurality of results; and
provide instructions to render the plurality of reordered results while maintaining the visualization.

10. The system of claim 8, wherein to cluster the plurality of results into a plurality of clusters, the instructions further cause the one or more processors to:
determine a threshold score based on the statistical measure of the scores associated with the plurality of results; and
assign the plurality of results to clusters based on a score associated with each of the plurality of results and the threshold score.

11. The system of claim 8, wherein to apply a visualization to the plurality of results based on the plurality of clusters, the instructions further cause the one or more processors to:
determine a visualization to apply to a cluster of the plurality of clusters; and
apply the visualization to each of the plurality of results in the cluster of the plurality of clusters.

12. The system of claim 11, wherein to determine the visualization to apply to a cluster of the plurality of clusters, the instructions further cause the one or more processors to:
determine a size for results associated with the cluster of the plurality of clusters based on the statistical measure of the distribution of scores associated with the plurality of results and a threshold score associated with the cluster of the plurality of clusters.

13. The system of claim 8, wherein the statistical measure is a statistical centrality measure.

14. The system of claim 8, wherein the instructions further cause the one or more processors to apply a second visualization to results associated with a cluster of the plurality of clusters, based on the statistical measure of the distribution of scores associated with the plurality of results, to distinguish between the results associated with the cluster.

15. A method comprising:
receiving a query;
responsive to the query, clustering a plurality of results, returned based on the query, into a plurality of clusters based on a deviation from a statistical measure of a distribution of scores associated with the plurality of results;
arranging the plurality of clusters based on the deviation from the statistical measure of the distribution of scores associated with the plurality of results;
applying a first visualization to the plurality of results based on the statistical measure of the distribution of scores associated with the plurality of results and a threshold score associated with the cluster of the plurality of clusters;
applying a second visualization to results associated with a cluster of the plurality of clusters, based on the statistical measure of the distribution of scores associated with the plurality of results, to distinguish between the results associated with the cluster; and
providing instructions to render the plurality of results with the first and second visualization.

16. The method claim 15, further comprising:
receiving a request to reorder the results based on a criterion other than the score; and
providing instructions to render the plurality of reordered results while maintaining the first and second visualization.

17. The method of claim 15, wherein the statistical measure is a statistical centrality measure.

18. The method of claim 15, wherein the first visualization comprises a size of a bounding region corresponding to results associated with the cluster.

19. The method of claim 15, wherein the second visualization comprises a font size for text corresponding to a result of the results associated with the cluster.

20. The method of claim 19, wherein to the font size is determined using a base font size, a score for the result, and the statistical measure.
